(19) United States
(12) Patent Application Publication
(10) Pub. No.: US 2024/0080771 A1
(43) Pub. Date: Mar. 7, 2024

(54) ENHANCED DISCONTINUOUS RECEPTION AND POWER SAVING FOR USER EQUIPMENT

(71) Applicant: Lenovo (Singapore) Pte. Ltd., New Tech Park (SG)

(72) Inventors: Hyejung Jung, Northbrook, IL (US); Joachim Loehr, Wiesbaden (DE); Vijay Nangia, Woodridge, IL (US)

(21) Appl. No.: 18/261,252

(22) PCT Filed: Jan. 14, 2023
(86) PCT No.: PCT/IB2022/050308

§ 371 Date: Jul. 12, 2023

Related U.S. Application Data
(60) Provisional application No. 63/137,565, filed on Jan. 14, 2021.

(51) Int. Cl. H04W 52/02; H04W 72/232; H04W 76/28

(52) U.S. Cl. CPC H04W 52/0235; H04W 52/0216; H04W 72/232; H04W 76/28

(57) ABSTRACT

Various aspects of the present disclosure relate to enhanced discontinuous reception and power saving for user equipment. An apparatus includes a transceiver that receives a physical downlink control channel (“PDCCH”) skipping indication for a group of search space sets via a downlink control information (“DCI”) from a network node during a PDCCH monitoring occasion and a processor that ceases monitoring PDCCH for the group of search space sets at least after an elapse of an application delay, in response to the PDCCH skipping indication indicating PDCCH skipping for the group of search space sets.

### CROSS-REFERENCE TO RELATED APPLICATIONS

This application claims priority to U.S. Provisional Patent Application No. 63/137,565 entitled “ENHANCED DISCONTINUOUS RECEPTION (DRX) AND POWER SAVING PDCCH FOR UE POWER SAVING” and filed on Jan. 14, 2021, for Hyejung Jung, et al., which is incorporated herein by reference.

### FIELD

The subject matter disclosed herein relates generally to wireless communications and more particularly relates to enhanced discontinuous reception and power saving for user equipment.

### BACKGROUND

In certain wireless communication systems, a wake-up indication is applicable to an entire discontinuous reception (“DRX”) cycle. Thus, if a delay-sensitive application is initiated for a user equipment (“UE”), the UE may have to be reconfigured from a long DRX cycle value to a short DRX cycle value in order to properly handle low-latency traffic.

### BRIEF SUMMARY

Disclosed are procedures for enhanced discontinuous reception and power saving for user equipment. Said procedures may be implemented by apparatus, systems, methods, and/or computer program products.

In one embodiment, a first apparatus includes a transceiver that receives a physical downlink control channel (“PDCCH”) skipping indication for a group of search space sets via a downlink control information (“DCI”) from a network node during a PDCCH monitoring occasion. In one embodiment, the first apparatus includes a processor that ceases monitoring PDCCH for the group of search space sets at least after an elapse of an application delay, in response to the PDCCH skipping indication indicating PDCCH skipping for the group of search space sets.

In one embodiment, a first method includes receiving a physical downlink control channel (“PDCCH”) skipping indication for a group of search space sets via a downlink control information (“DCI”) from a network node during a PDCCH monitoring occasion. In one embodiment, the first method includes ceasing monitoring PDCCH for the group of search space sets at least after an elapse of an application delay, in response to the PDCCH skipping indication indicating PDCCH skipping for the group of search space sets.

In one embodiment, a second apparatus includes a transceiver that transmits a physical downlink control channel (“PDCCH”) skipping indication for a group of search space sets configured for a user equipment (“UE”) device via a downlink control information (“DCI”) during a PDCCH monitoring occasion and a processor that ceases transmitting PDCCH for the group of search space sets at least after an elapse of an application delay, in response to transmitting the PDCCH skipping indication indicating PDCCH skipping for the group of search space sets.

In one embodiment, a second method includes transmitting a physical downlink control channel (“PDCCH”) skipping indication for a group of search space sets configured for a user equipment (“UE”) device via a downlink control information (“DCI”) during a PDCCH monitoring occasion and ceasing transmitting PDCCH for the group of search space sets at least after an elapse of an application delay, in response to transmitting the PDCCH skipping indication indicating PDCCH skipping for the group of search space sets.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for enhanced discontinuous reception and power saving for user equipment;

FIG. 2 is a block diagram illustrating one embodiment of a user equipment apparatus that may be used for enhanced discontinuous reception and power saving for user equipment;

FIG. 3 is a block diagram illustrating one embodiment of a network apparatus that may be used for enhanced discontinuous reception and power saving for user equipment;

FIG. 4 is a flowchart diagram illustrating one embodiment of a method for enhanced discontinuous reception and power saving for user equipment; and

FIG. 5 is a flowchart diagram illustrating one embodiment of another method for enhanced discontinuous reception and power saving for user equipment.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for enhanced discontinuous reception and power saving for user equipment. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

According to a Rel-17 Work Item Description (“WID”) for UE power saving Enhancements (RP-193239), the following objectives are defined:
i. Study and specify, if agreed, enhancements on power saving techniques for connected-mode UE, subject to minimized system performance impact
   1. Study and specify, if agreed, extension(s) to Rel-16 DCI-based power saving adaptation during DRX Active Time for an active BWP, including physical downlink control channel (“PDCCH”) monitoring reduction when C-DRX is configured
      a. NOTE: Rel-15 and Rel-16 available power saving solutions should be supported by the UE and included in the evaluation. RAN1 will ask the confirmation from RAN2 that Rel-15 and Rel-16 available power saving solutions are properly utilized.

During RAN1 #103-e meeting, RAN1 made the following agreements for enhanced DCI-based power saving adaptation during DRX active time:
i. Specify at least one of the following options for Rel-17 dynamic PDCCH adaptation for active time:
   1. Option 1: Search space set group switching, e.g., including explicit and implicit search space set group switching.
   2. Option 2: PDCCH skipping for a certain duration/DRX cycle.
ii. Candidate downlink control information (“DCI”) formats for dynamic PDCCH adaptation include DCI formats 1_1 (including scheduling and non-scheduling DCI), 0_1, 1_2, 0_2, 2_0, 2_6.
iii. Note—Companies are encouraged to provide analysis on specification impact, power saving benefit and system impact (e.g., packet latency, system overhead)

In Rel-16 new radio (“NR”), a wake-up indication is applicable to an entire DRX cycle. Thus, if a delay sensitive application is initiated for a UE, the UE may have to be reconfigured with from a long DRX cycle value to a short DRX cycle value in order to properly handle low-latency traffic.

In the proposed method, a UE may be configured with a relatively large DRX cycle value (e.g., 300 ms, 1000 ms) for power saving. For sporadic low-latency traffic or traffics with mixed characteristics, a network entity can adaptively adjust UE's PDCCH monitoring behavior by indicating to the UE at a regular monitoring occasion (1) not to wake up but to perform additional monitoring of the power saving PDCCH on additional monitoring occasions configured within a following DRX cycle or (2) not to wake up over one or several DRX cycles, without RRC reconfiguration of DRX configuration.

In this disclosure, enhanced DRX and power saving PDCCH operations that can flexibly adapt to various traffic conditions and can provide power saving gains even for sporadic low-latency traffics are proposed.

In one embodiment, a UE in C-DRX operation determines a first set of monitoring occasions and a second set of monitoring occasions for power saving PDCCH. Further, the UE can be indicated, via a power saving PDCCH detected on a monitoring occasion of the first set of monitoring occasions, not to wake-up to monitor PDCCH for a following DRX cycle but to monitor another power saving PDCCH on at least one monitoring occasion of the second set of monitoring occasions that is within the following DRX cycle.

In another embodiment, a UE receives a PDCCH skipping indication for each group of search space sets via a DCI format with scheduling information or via a DCI format without scheduling information. The time when the UE starts PDCCH skipping is determined based on whether there is at least one active search space set and whether there is any potential retransmission.

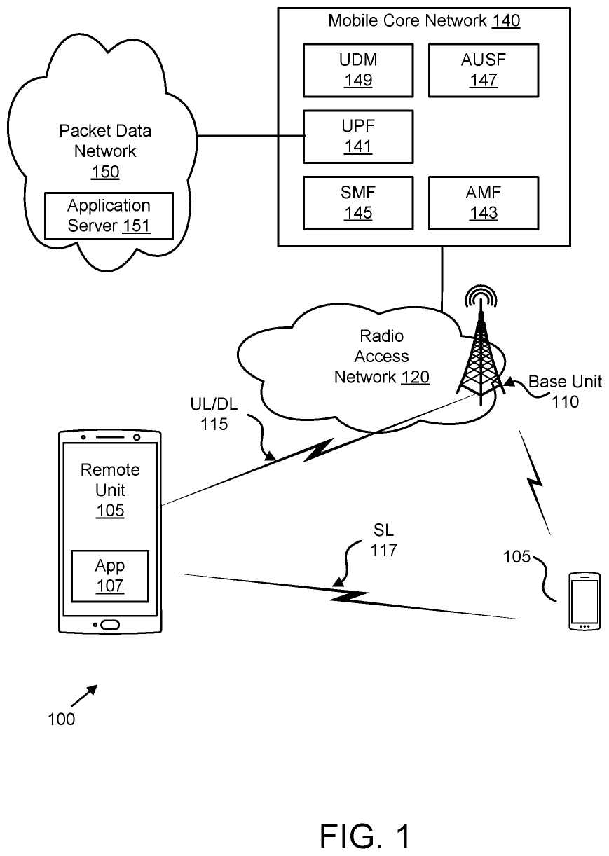

FIG. 1 depicts a wireless communication system 100 supporting enhanced discontinuous reception and power saving for user equipment, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 110 with which the remote unit 105 communicates using wireless communication links 115. Even though a specific number of remote units 105, base units 110, wireless communication links 115, RANs 120, and mobile core networks 140 are depicted in FIG. 1, one of skill in the art will recognize that any number of remote units 105, base units 110, wireless communication links 115, RANs 120, and mobile core networks 140 may be included in the wireless communication system 100.

In one implementation, the RAN 120 is compliant with the 5G system specified in the 3GPP specifications. In another implementation, the RAN 120 is compliant with the LTE system specified in the 3GPP specifications. More generally, however, the wireless communication system 100 may implement some other open or proprietary communication network, for example WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 110 in the RAN 120 via uplink (“UL”) and downlink (“DL”) communication signals. Furthermore, the UL and DL communication signals may be carried over the wireless communication links 115. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone/VoIP application) in a remote unit 105 may trigger the remote unit 105 to establish a PDU session (or other data connection) with the mobile core network 140 via the RAN 120. The mobile core network 140 then relays traffic between the remote unit 105 and the application server 151 in the packet data network 150 using the PDU session. Note that the remote unit 105 may establish one or more PDU sessions (or other data connections) with the mobile core network 140. As such, the remote unit 105 may concurrently have at least one PDU session for communicating with the packet data network 150 and at least one PDU session for communicating with another data network (not shown).

The base units 110 may be distributed over a geographic region. In certain embodiments, a base unit 110 may also be referred to as an access terminal, an access point, a base, a base station, a Node-B, an eNB, a gNB, a Home Node-B, a relay node, a RAN node, or by any other terminology used in the art. The base units 110 are generally part of a radio access network (“RAN”), such as the RAN 120, that may include one or more controllers communicably coupled to one or more corresponding base units 110. These and other elements of radio access network are not illustrated but are well known generally by those having ordinary skill in the art. The base units 110 connect to the mobile core network 140 via the RAN 120.

The base units 110 may serve a number of remote units 105 within a serving area, for example, a cell or a cell sector, via a wireless communication link 115. The base units 110 may communicate directly with one or more of the remote units 105 via communication signals. Generally, the base units 110 transmit DL communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. The wireless communication links 115 facilitate communication between one or more of the remote units 105 and/or one or more of the base units 110. Note that the base unit 110 and the remote unit 105 may communicate over unlicensed radio spectrum.

In one embodiment, the mobile core network 140 is a 5G core (“5GC”) or the evolved packet core (“EPC”), which may be coupled to a packet data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes multiple user plane functions (“UPFs”) 141. The mobile core network 140 also includes multiple control plane functions including, but not limited to, an Access and Mobility Management Function (“AMF”) 143 that serves the RAN 120, a Session Management Function (“SMF”) 145, an Authentication Server Function (“AUSF”) 147, and a Unified Data Management function (“UDM”) 149. In certain embodiments, the mobile core network 140 may also include a Policy Control Function (“PCF”), a Network Repository Function (“NRF”) (used by the various NFs to discover and communicate with each other over APIs), or other NFs defined for the 5GC.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like. In certain embodiments, the mobile core network 140 may include a AAA server.

In various embodiments, the remote units 105 may communicate directly with each other (e.g., device-to-device communication) using sidelink (“SL”) communication signals 117. V2X is one example of SL communication. Here, V2X transmissions may occur on V2X resources. The remote unit 105 may be provided with different V2X communication resources for different V2X modes. Mode-1 corresponds to a NR network-scheduled V2X communication mode. Mode-2 corresponds to an LTE network-scheduled V2X communication mode.

While FIG. 1 depicts components of a 5G RAN and a 5G core network, the described embodiments apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF 141 may be mapped to an MME, the SMF mapped to a control plane portion of a PGW and/or to an MME, the UPF map to an SGW and a user plane portion of the PGW, the UDM/UDR maps to an HSS, etc.

In the following descriptions, the term “gNB” is used for the base station but it is replaceable by any other radio access node, e.g., RAN node, eNB, BS, eNB, gNB, AP, NR, etc. Further the operations are described mainly in the context of 5G NR.

In Rel-16 NR, a UE that is in a radio resource control (“RRC”) connected mode and is configured with one or more DRX configurations (e.g., via RRC IEs ‘DRX-Config’ and additionally ‘DRX-ConfigSecondaryGroup’) may also be configured with a bandwidth part (“BWP”) including configuration information of a power saving PDCCH (i.e., DCI format 2_6). If the BWP including the configuration information of the power saving PDCCH is an active BWP of the UE, the UE monitors the power saving PDCCH. One or more monitoring occasion(s) of the power saving PDCCH can be configured within a slot or multiple slots before a start of a DRX ON duration (e.g., outside the “Active Time” during which the UE performs PDCCH monitoring).

The UE starts monitoring the power saving PDCCH with cyclic redundancy check (“CRC”) scrambled by power saving-radio network temporary identifier (“PS-RNTI”) at a configured power saving offset value (e.g., denoted as PS_offset) before the start of the DRX ON duration until the end of a configured range of monitoring. The range of monitoring is determined based on search space configuration of the power saving PDCCH (e.g., based on parameters ‘monitoringSlotPeriodicityAndOffset’, ‘duration’, and ‘monitoringSymbolsWithinSlot’), and it is smaller than the configured power saving offset value (e.g., PS_offset) in order to provide the UE with sufficient time to prepare for PDCCH monitoring at the start of the DRX ON duration. If the UE is in DRX Active Time during a power saving PDCCH monitoring occasion(s), the UE starts the drx-onDurationTimer at the beginning of the next DRX cycle.

Regarding PDCCH monitoring indication and dormancy/non-dormancy behavior for SCells (e.g., from 3GPP TS 38.213), in one embodiment, a UE configured with DRX mode operation can be provided the following for detection of a DCI format 2_6 in a PDCCH reception on the PCell or on the SpCell:
i. a PS-RNTI for DCI format 2_6 by ps-RNTI;
ii. a number of search space sets, by dci-Format2-6, to monitor PDCCH for detection of DCI format 2_6 on the active DL BWP of the PCell or of the SpCell according to a common search space as described in Clause 10.1;
iii. a payload size for DCI format 2_6 by sizeDCI_2-6;
iv. a location in DCI format 2_6 of a Wake-up indication bit by psPositionDCI-2-6 where:
   1. a ‘0’ value for the Wake-up indication bit, when reported to higher layers, indicates to not start the drx-onDurationTimer for the next long DRX cycle;
   2. a ‘1’ value for the Wake-up indication bit, when reported to higher layers, indicates to start the drx-onDurationTimer for the next long DRX cycle.
v. a bitmap, when the UE is provided a number of groups of configured SCells by dormancyGroupOutsideActiveTime, where:
   1. the bitmap location is immediately after the Wake-up indication bit location;
   2. the bitmap size is equal to the number of groups of configured SCells where each bit of the bitmap corresponds to a group of configured SCells from the number of groups of configured SCells;
   3. a ‘0’ value for a bit of the bitmap indicates an active DL BWP, provided by dormantBWP-Id, for the UE for each activated SCell in the corresponding group of configured SCells;
   4. a ‘1’ value for a bit of the bitmap indicates:
      a. an active DL BWP, provided byfirstOutsideActiveTimeBWP-Id, for the UE for each activated SCell in the corresponding group of configured SCells, if a current active DL BWP is the dormant DL BWP;
      b. a current active DL BWP, for the UE for each activated SCell in the corresponding group of configured SCells, if the current active DL BWP is not the dormant DL BWP.
vi. an offset by ps-Offset indicating a time, where the UE starts monitoring PDCCH for detection of DCI format 2_6 according to the number of search space sets, prior to a slot where the drx-onDuarationTimer would start on the PCell or on the SpCell
   1. for each search space set, the PDCCH monitoring occasions are the ones in the first Tₛ slots indicated by duration, or Tₛ=1 slot if duration is not provided, starting from the first slot of the first Tₛ slots and ending prior to the start of drx-onDurationTimer.

On PDCCH monitoring occasions associated with a same long DRX Cycle, in one embodiment, a UE does not expect to detect more than one DCI format 2_6 with different values of the Wake-up indication bit for the UE or with different values of the bitmap for the UE.

In one embodiment, the UE does not monitor PDCCH for detecting DCI format 2_6 during Active Time.

If a UE reports for an active DL BWP a requirement of X slots prior to the beginning of a slot where the UE would start the drx-onDurationTimer, in one embodiment, the UE is not required to monitor PDCCH for detection of DCI format 2_6 during the X slots, where X corresponds to the requirement of the subcarrier spacing (“SCS”) of the active DL BWP in Table 1.

TABLE 1
Minimum time gap value X

Minimum Time Gap X (slots)

| SCS (kHz) | Value 1 | Value 2 |
|---|---|---|
| 15 | 1 | 3 |
| 30 | 1 | 6 |
| 60 | 1 | 12 |
| 120 | 2 | 24 |

If a UE is provided search space sets to monitor PDCCH for detection of DCI format 2_6 in the active DL BWP of the PCell or of the SpCell and the UE detects DCI format 2_6, in one embodiment, the physical layer of a UE reports the value of the Wake-up indication bit for the UE to higher layers for the next long DRX cycle.

If a UE is provided search space sets to monitor PDCCH for detection of DCI format 2_6 in the active DL BWP of the PCell or of the SpCell and the UE does not detect DCI format 2_6, in one embodiment, the physical layer of the UE does not report a value of the Wake-up indication bit to higher layers for the next long DRX cycle.

If a UE is provided search space sets to monitor PDCCH for detection of DCI format 2_6 in the active DL BWP of the PCell or of the SpCell and the UE:
i. is not required to monitor PDCCH for detection of DCI format 2_6 for all corresponding PDCCH monitoring occasions outside Active Time prior to a next long DRX cycle, or
ii. does not have any PDCCH monitoring occasions for detection of DCI format 2_6 outside Active Time of a next long DRX cycle,

the physical layer of the UE reports a value of 1 for the Wake-up indication bit to higher layers for the next long DRX cycle.

Regarding search space group switching, in one embodiment, a UE can be provided with a group index for a respective Type3-PDCCH CSS set or USS set by searchSpaceGroupIdList-r16 for PDCCH monitoring on a serving cell. If the UE is not provided searchSpaceGroupIdList-r16 for a search space set, the following procedures are not applicable for PDCCH monitoring according to the search space set.

If a UE is provided searchSpaceSwitchingGroupList-r16, in one embodiment, indicating one or more groups of serving cells, the following procedures apply to all serving cells within each group; otherwise, the following procedures apply only to a serving cell for which the UE is provided searchSpaceGroupIdList-r16.

When a UE is provided searchSpaceGroupIDList-r16, in one embodiment, the UE resets PDCCH monitoring according to search space sets with group index 0, if provided by searchSpaceGroupIdList-r16.

A UE can be provided by searchSpaceSwitchingDelay-r16 with a number of symbols P_{switch} where a minimum value of P_{switch} is provided in Table 2 for UE processing capability 1 and UE processing capability 2 and SCS configuration μ. UE processing capability 1 for SCS configuration μ applies unless the UE indicates support for UE processing capability 2.

TABLE 2
Minimum value of P_{switch} [symbols]

| | Minimum P_{switch} value for | Minimum P_{switch} value for |
|---|---|---|
| | UE processing capability 1 | UE processing capability 2 |
| μ | [symbols] | [symbols] |
| 0 | 25 | 10 |
| 1 | 25 | 12 |
| 2 | 25 | 22 |

A UE can be provided, in one embodiment, by searchSpaceSwitchingTimer-r16, a timer value for a serving cell that the UE is provided searchSpaceGroupldList-r16 or, if provided, for a set of serving cells provided by searchSpaceSwitchingGroupList-r16. The UE decrements the timer value by one after each slot based on a reference SCS configuration that is the smallest SCS configuration μ among all configured DL BWPs in the serving cell, or in the set of serving cells. The UE maintains the reference SCS configuration during the timer decrement procedure.

In one embodiment, if a UE is provided by SearchSpaceSwitchTrigger-r16 a location of a search space set group switching flag field for a serving cell in a DCI format 2_0, and:
i. if the UE detects a DCI format 2_0 and a value of the search space set group switching flag field in the DCI format 2_0 is 0, the UE starts monitoring PDCCH according to search space sets with group index 0, and stops monitoring PDCCH according to search space sets with group index 1, on the serving cell at a first slot that is at least P_{switch} symbols after the last symbol of the PDCCH with the DCI format 2_0;
ii. if the UE detects a DCI format 2_0 and a value of the search space set group switching flag field in the DCI format 2_0 is 1, the UE starts monitoring PDCCH according to search space sets with group index 1, and stops monitoring PDCCH according to search space sets with group index 0, on the serving cell at a first slot that is at least P_{switch} symbols after the last symbol of the PDCCH with the DCI format 2_0, and the UE sets the timer value to the value provided by searchSpaceSwitchingTimer-r16; and/or
iii. if the UE monitors PDCCH on a serving cell according to search space sets with group index 1, the UE starts monitoring PDCCH on the serving cell according to search space sets with group index 0, and stops monitoring PDCCH according to search space sets with group index 1, on the serving cell at the beginning of the first slot that is at least P_{switch} symbols after a slot where the timer expires or after a last symbol of a remaining channel occupancy duration for the serving cell that is indicated by DCI format 2_0

If a UE is not provided SearchSpaceSwitchTrigger-r16 for a serving cell, and:
i. if the UE detects a DCI format by monitoring PDCCH according to a search space set with group index 0, the UE starts monitoring PDCCH according to search space sets with group index 1, and stops monitoring PDCCH according to search space sets with group index 0, on the serving cell at a first slot that is at least P_{switch} symbols after the last symbol of the PDCCH with the DCI format, the UE sets the timer value to the value provided by searchSpaceSwitchingTimer-r16 if the UE detects a DCI format by monitoring PDCCH in any search space set; and/or
ii. if the UE monitors PDCCH on a serving cell according to search space sets with group index 1, the UE starts monitoring PDCCH on the serving cell according to search space sets with group index 0, and stops monitoring PDCCH according to search space sets with group index 1, on the serving cell at the beginning of the first slot that is at least P_{switch} symbols after a slot where the timer expires or, if the UE is provided a search space set to monitor PDCCH for detecting a DCI format 2_0, after a last symbol of a remaining channel occupancy duration for the serving cell that is indicated by DCI format 2_0

A UE, in one embodiment, determines a slot and a symbol in the slot to start or stop PDCCH monitoring according to search space sets for a serving cell that the UE is provided searchSpaceGroupldList-r16 or, if searchSpaceSwitchingGroupList-r16 is provided, for a set of serving cells, based on the smallest SCS configuration μ among all configured DL BWPs in the serving cell or in the set of serving cells and, if any, in the serving cell where the UE receives a PDCCH and detects a corresponding DCI format 2_0 triggering the start or stop of PDCCH monitoring according to search space sets.

In one embodiment, DCI format 2_0 (e.g., from 3GPP TS 38.212) is used for notifying the slot format, channel occupancy time (“COT”) duration, available resource block (“RB”) set, and search space set group switching.

The following information may be transmitted by means of the DCI format 2_0 with CRC scrambled by slot format indication (“SFI”)-RNTI:
i. If the higher layer parameter slotFormatCombToAddModList is configured, 1. Slot format indicator 1, Slot format indicator 2, . . . , Slot format indicator N,
ii. If the higher layer parameter availableRB-SetsToAddModList-r16 is configured,
   1. Available RB set Indicator 1, Available RB set Indicator 2, . . . , Available RB set Indicator N1,
iii. If the higher layer parameter co-DurationsPerCellToAddModList-r16 is configured
   1. COT duration indicator 1, COT duration indicator 2, . . . , COT duration indicator N2.
iv. If the higher layer parameter searchSpaceSwitchTriggerToAddModList-r16 is configured
   1. Search space set group switching flag 1, Search space set group switching flag 2, . . . , Search space set group switching flag M.

The size of DCI format 2_0 may be configurable by higher layers up to 128 bits.

In one embodiment, DCI format 2_6 (e.g., from 3GPP TS 38.212) is used for notifying the power saving information outside DRX Active Time for one or more UEs.

In one embodiment, the following information is transmitted by means of the DCI format 2_6 with CRC scrambled by PS-RNTI:
a. block number 1, block number 2, . . . , block number N
   where the starting position of a block is determined by the parameter ps-PositionDCI-2-6 provided by higher layers for the UE configured with the block.

In one embodiment, if the UE is configured with higher layer parameter ps-RNTI and dci-Format2-6, one block is configured for the UE by higher layers, with the following fields defined for the block:
i. Wake-up indication—1 bit
ii. SCell dormancy indication—0 bit if higher layer parameter dormancyGroupOutsideActiveTime is not configured; otherwise 1, 2, 3, 4 or 5 bits bitmap determined according to higher layer parameter dormancyGroupOutsideActiveTime, where each bit corresponds to one of the SCell group(s) configured by higher layers parameter dormancyGroupOutsideActiveTime, with most significant bit (“MSB”) to least significant bit (“LSB”) of the bitmap corresponding to the first to last configured SCell group.

The size of DCI format 2_6 may be indicated by the higher layer parameter sizeDCI-2-6.

Regarding DRX (e.g., from 3GPP TS 38.321), the medium access control (“MAC”) entity may be configured by RRC with a DRX functionality that controls the UE's PDCCH monitoring activity for the MAC entity's cell (“C”)-RNTI, cancellation indication (“CI”)-RNTI, configured scheduling (“CS”)-RNTI, interruption (“INT”)-RNTI, SFI-RNTI, semi-persistent (“SP”)-channel state information (“CSI”)-RNTI, transmit power control (“TPC”)-physical uplink control channel (“PUCCH”)-RNTI, TPC-physical uplink shared channel (“PUSCH”)-RNTI, TPC-sounding reference signal (“SRS”)-RNTI, and availability indication (“AI”)-RNTI. When using DRX operation, the MAC entity shall also monitor PDCCH according to requirements found in other clauses of this specification. When in RRC CONNECTED, if DRX is configured, for all the activated Serving Cells, the MAC entity may monitor the PDCCH discontinuously using the DRX operation specified in this clause; otherwise, the MAC entity shall monitor the PDCCH.
i. NOTE 1: If sidelink resource allocation mode 1 is configured by RRC, a DRX functionality is not configured.

In one embodiment, RRC controls DRX operation by configuring the following parameters:
i. drx-onDurationTimer: the duration at the beginning of a DRX cycle;
ii. drx-SlotOffset: the delay before starting the drx-onDurationTimer;
iii. drx-InactivityTimer: the duration after the PDCCH occasion in which a PDCCH indicates a new UL or DL transmission for the MAC entity;
iv. drx-RetransmissionTimerDL (per DL HARQ process except for the broadcast process): the maximum duration until a DL retransmission is received;
v. drx-RetransmissionTimerUL (per UL HARQ process): the maximum duration until a grant for UL retransmission is received;
vi. drx-LongCycleStartOffset: the Long DRX cycle and drx-StartOffset which defines the subframe where the Long and Short DRX cycle starts;
vii. drx-ShortCycle (optional): the Short DRX cycle;
viii. drx-ShortCycleTimer (optional): the duration the UE shall follow the Short DRX cycle;
ix. drx-HARQ-RTT-TimerDL (per DL HARQ process except for the broadcast process): the minimum duration before a DL assignment for HARQ retransmission is expected by the MAC entity;
x. drx-HARQ-RTT-TimerUL (per UL HARQ process): the minimum duration before a UL HARQ retransmission grant is expected by the MAC entity;
xi. ps-Wakeup (optional): the configuration to start associated drx-onDurationTimer in case DCP is monitored but not detected;
xii. ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started;
xiii. ps-TransmitPeriodicL1-RSRP (optional): the configuration to transmit periodic CSI that is L1-RSRP on PUCCH during the time duration indicated by drx-onDurationTimer in case DCP is configured but associated drx-onDurationTimer is not started.

In one embodiment, serving cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, and drx-HARQ-RTT-TimerUL.

When a DRX cycle is configured, in one embodiment, the active time for serving cells in a DRX group includes the time while:
i. drx-onDurationTimer or drx-InactivityTimer configured for the DRX group is running; or
ii. drx-RetransmissionTimerDL or drx-RetransmissionTimerUL is running on any Serving Cell in the DRX group; or
iii. ra-ContentionResolutionTimer or msgB-Response Window is running; or
iv. a Scheduling Request is sent on PUCCH and is pending; or
v. a PDCCH indicating a new transmission addressed to the C-RNTI of the MAC entity has not been received after successful reception of a Random Access Response for the Random Access Preamble not selected by the MAC entity among the contention-based Random Access Preamble.

In a first embodiment of the proposed solution, enhanced DRX operation with enhanced US power saving DCI is discussed. In one embodiment, a UE in connected mode-DRX (C-DRX) operation determines a first set of monitoring occasions and a second set of monitoring occasions for power saving PDCCH. Further, the UE may be indicated, via a power saving PDCCH detected on a monitoring occasion of the first set of monitoring occasions, not to wake-up to monitor PDCCH for a following (e.g., next) DRX cycle (e.g., the UE does not start a DRX ON duration by not starting a ‘drx-onDurationTimer’) but to monitor another power saving PDCCH on at least one monitoring occasion of the second set of monitoring occasions that is within the following DRX cycle.

The UE, in one embodiment, receives configuration information of a power saving PDCCH (e.g., a DCI format with CRC scrambled with PS-RNTI) including at least one search space set and an associated control resource set (“CORESET”), where the at least one search space set includes information of a plurality of monitoring occasions that comprise a plurality of regular monitoring occasions (e.g., the first set of monitoring occasions) and a plurality of additional monitoring occasions (e.g., the second set of monitoring occasions) for the power saving PDCCH.

In one example, a first search space set of the at least one search space set includes information of a plurality of monitoring occasions that comprise a plurality of regular monitoring occasions (e.g., the first set of monitoring occasions) and a second search space set of the at least one search space set includes information of a plurality of additional monitoring occasions (e.g., the second set of monitoring occasions) for the power saving PDCCH. The plurality of regular monitoring occasions comprises monitoring occasions occurring in a time interval of each DRX cycle, where a starting time of the time interval is determined by a first time offset (indicated via parameter ps-Offset) prior to the beginning of a slot where a following DRX cycle starts, and an ending time of the time interval is determined by a second time offset prior to the beginning of a slot where the following DRX cycle starts. The second time offset is determined by the required minimum time gap value X in slots before the UE would start the drx-onDurationTimer, which the UE may report as a part of capability information (if not reported, X is assumed to be zero). The plurality of additional monitoring occasions comprise monitoring occasions not included in the time interval (defined above) of each DRX cycle.

In one embodiment, the UE performs monitoring of the power saving PDCCH on the plurality of regular monitoring occasions and detects the DCI format of the power saving PDCCH that includes an indication selected from, for example:
i. to wake up over Y1 number of following DRX cycles (e.g., Y1 is selected from a first set of configured values, e.g. {1, 2, 4, 8}).
   1. The UE skips monitoring the power saving PDCCH on regular monitoring occasions within the following (Y1-1) consecutive DRX cycles.
ii. not to wake up over Y2 number of DRX cycles (e.g., Y2 is selected from a second set of configured values, e.g. {1, 2, 3, 4}).
   1. The UE skips monitoring the power saving PDCCH on regular monitoring occasions within the following (Y2-1) consecutive DRX cycles.
iii. not to wake up in a following DRX cycle but to monitor the power saving PDCCH on one or more additional monitoring occasions within the following DRX cycle.

Upon receiving, at a regular monitoring occasion(s) of the power saving PDCCH, the indication not to wake up in the following DRX cycle but to monitor the power saving PDCCH on the one or more additional monitoring occasions within the following DRX cycle, in one embodiment, the UE neither fully wakes up for PDCCH monitoring (e.g., monitoring a PDCCH of a DL assignment, an UL grant, an uplink power control command, a slot format indication, DL preemption, and/or UL cancellation) nor starts the drx-onDurationTimer at the beginning of the following DRX cycle, but goes back to a sleep state and later partially wakes up for monitoring the power saving PDCCH at the one or more additional monitoring occasions. In one embodiment, the UE performs monitoring of the power saving PDCCH on the one or more additional monitoring occasions of the DRX cycle and detects the DCI format of the power saving PDCCH that includes an indication selected from one or more of, for example:
i. to wake up and start drx-onDurationTimer2 for the DRX cycle (drx-onDurationTimer2 is used for an ON duration that can start at any time within the DRX cycle). The UE is in DRX Active Time and the Active Time includes the time (in addition to the condition defined in TS 38.321 (V16.3.0)) while the drx-onDurationTimer2 is running;
ii. to wake up and start the drx-onDurationTimer for the DRX cycle. The duration of the drx-onDurationTimer is reduced (from the configured initial value) by an offset. The offset may be the time corresponding to between the slot where the UE would start the drx-onDurationTimer and X slots after the slot in which the UE detects the DCI format of the power saving PDCCH, where X is required minimum time gap (in slots) between reception of the wake-up indication and starting of PDCCH monitoring. In another example, the offset may correspond to the time between when the UE would start the drx-onDurationTimer and the first time duration (as described below) delay after the end of the additional monitoring occasion where the UE detects the DCI format of the power saving PDCCH;
iii. to wake up and start the drx-InactivityTimer for the DRX cycle;
iv. to wake up and start a timer, e.g., ps-WakeupTimer for the DRX cycle. The UE is in DRX Active Time and the Active Time includes the time while the ps-WakeupTimer is running. The duration of the ps-WakeupTimer is based on the duration of the drx-onDurationTimer and when (e.g., slot in which) the UE detects the DCI format of the power saving PDCCH. In one example, the duration of the timer is set to the initial value of the drx-onDurationTimer less an offset. The offset may be the time corresponding to between the slot where the UE would start the drx-onDurationTimer and X slots after the slot in which the UE detects the DCI format of the power saving PDCCH, where X is required minimum time gap (in slots) between reception of the wake-up indication and starting of PDCCH monitoring. In another example, the offset may correspond to the time between when the UE would start the drx-onDurationTimer and the first time duration (as described below) delay after the end of the additional monitoring occasion where the UE detects the DCI format of the power saving PDCCH;
v. not to wake up but to continue monitoring the power saving PDCCH on the remaining additional monitoring occasions within the DRX cycle.

In another example, the indication is selected from:
i. to wake up over Y1 number of DRX cycles including the DRX cycle (e.g., Y1 is selected from a first set of configured values, e.g. {1, 2, 4, 8}).
   1. The UE starts the drx-onDurationTimer2 (or ps-WakeupTimer or drx-onDurationTimer with reduced duration) for the DRX cycle, stops monitoring the power saving PDCCH on the remaining additional monitoring occasions within the DRX cycle, and skips monitoring the power saving PDCCH on regular monitoring occasions within the following (Y1-1) consecutive DRX cycles.
ii. not to wake up over Y2 number of DRX cycles (e.g., Y2 is selected from a second set of configured values, e.g. {1, 2, 3, 4}).
   1. The UE stops monitoring the power saving PDCCH on the remaining additional monitoring occasions within the DRX cycle and skips monitoring the power saving PDCCH on regular monitoring occasions within the following (Y2-1) consecutive DRX cycles.
iii. not to wake up but to continue monitoring the power saving PDCCH on the remaining additional monitoring occasions within the DRX cycle

In one embodiment, if the UE receives an indication to wake up at an additional monitoring occasion within a DRX cycle, the UE wakes up and starts to monitor PDCCH (e.g, starts the drx-onDurationTimer2 (or ps-WakeupTimer or drx-onDurationTimer with reduced duration) for the DRX cycle) at a first time duration after an end of the additional monitoring occasion where the UE detects the DCI format of the power saving PDCCH. The first time duration is based on the required minimum time gap between reception of the wake-up indication and starting of PDCCH monitoring and can be determined by the UE based on the reported minimum time gap or can be configured by a network entity. A value for drx-onDurationTimer2 may be set to be same as or different than a value of the drx-onDurationTimer.

In one embodiment, if the UE receives, at an additional monitoring occasion within a DRX cycle, an indication not to wake up without additional monitoring of the power saving PDCCH, the UE does not monitor the power saving PDCCH on the remaining additional monitoring occasions within the DRX cycle but monitors the power saving PDCCH at a regular monitoring occasion(s) of the DRX cycle.

In one embodiment, if the UE receives, at an additional monitoring occasion within a DRX cycle, an indication not to wake up with additional monitoring of the power saving PDCCH, the UE does not start the drx-onDurationTimer2 (or ps-WakeupTimer or drx-onDurationTimer with reduced duration) for the DRX cycle but continues monitoring the power saving PDCCH at the next additional monitoring occasion(s) within the DRX cycle.

In one embodiment, a UE may be configured with a DRX cycle with a relatively large DRX cycle value (e.g., 300 ms, 600 ms, 1000 ms) for power saving. If a delay sensitive application is initiated for the UE and there is no imminent packet at a buffer that needs to be delivered to the UE, a network entity may indicate to the UE at a regular monitoring occasion not to wake up but to perform additional monitoring of the power saving PDCCH on additional monitoring occasions configured within the next DRX cycle. By monitoring the PDCCH-based power saving channel on the additional monitoring occasions configured throughout the next DRX cycle, the UE would not miss a delay sensitive packet(s) while being in the “sleep” state for most of the time in the next DRX cycle if there is no data to transmit or receive.

In one example, a UE is indicated via a 2-bit DCI bit field to wake up, not to wake up over a first number of following DRX cycles, not to wake up over a second number of following DRX cycles, and not to wake up with additional monitoring of the power saving PDCCH within the next DRX cycle.

In another example, DCI format 2_6z is used for notifying the enhanced power saving information outside DRX Active Time for one or more UEs.

The following information is transmitted by means of the DCI format 2_6z with CRC scrambled by PS-RNTI:
i. block number 1, block number 2, . . . , block number N where the starting position of a block is determined by the parameter ps-PositionDCI-2-6z provided by higher layers for the UE configured with the block.

If the UE is configured with higher layer parameter ps-RNTI and dci-Format2-6z, one block is configured for the UE by higher layers, with the following fields defined for the block:
i. Wake-up indication—2 bits; 00: wake up, 01: not to wake up over Y1 DRX cycles, 10: not to wake up over Y2 DRX cycles, 11: not to wake up but to continue monitor on additional monitoring occasions within the next DRX cycle;
ii. SCell dormancy indication—0 bit if higher layer parameter dormancyGroupOutsideActiveTime is not configured; otherwise 1, 2, 3, 4 or 5 bits bitmap determined according to higher layer parameter dormancyGroupOutsideActiveTime, where each bit corresponds to one of the SCell group(s) configured by higher layers parameter dormancyGroupOutsideActiveTime, with MSB to LSB of the bitmap corresponding to the first to last configured SCell group.

In one embodiment, the size of DCI format 2_6z is indicated by the higher layer parameter sizeDCI-2-6z.

In another example, a network entity may configure a set of UEs for a power saving PDCCH on a regular monitoring occasion of a UE, differently from a set of UEs for a power saving PDCCH on an additional monitoring occasion of the UE. Thus, the UE receives separate configurations of power saving PDCCH, one for regular monitoring occasions and the other for additional monitoring occasions. For example, PS-RNTI, a number of search space sets by dci-Format2-6z, a payload size for DCI format 2_6 by sizeDCI_2-6z, and/or a starting position in DCI format 2_6z by psPositionDCI-2-6z may be separately configured for monitoring a power saving PDCCH on the additional monitoring occasions. The UE may further receive a separate configuration of ps-Wakeup, the configuration to start associated drx-onDurationTimer2 (or ps-WakeupTimer or drx-onDurationTimer with reduced duration) in case a power saving PDCCH is monitored but not detected on an additional monitoring occasion.

In a second embodiment of the proposed solution, a UE receives a PDCCH skipping indication (e.g., whether to stop/skip PDCCH monitoring or to restart PDCCH monitoring) for each search space set or for each group of search space sets via a DCI format with scheduling information (e.g., DL assignment, UL grant, DL SPS activation/release, type2 configured grant (“CG”)-PUSCH activation/release) or via a DCI format without scheduling information.

In one embodiment, if a PDCCH skipping indication indicates PDCCH skipping for a UE-specific search space set and if there is at least one active UE-specific search space set not including the indicated search space set (e.g., at least one UE-specific search space set for which PDCCH is not skipped), the UE stops monitoring PDCCH for the indicated search space set, starting from an application delay after an end of PDCCH reception including the indication (or an end of a monitoring occasion where the indication is received). The application delay can be higher-layer configured and/or dynamically indicated in DCI with the PDCCH skipping indication by a network entity.

In one embodiment, if a PDCCH skipping indication indicates PDCCH skipping for a UE-specific search space set and if there is no active UE-specific search space set not including the indicated search space set (e.g., PDCCH skipping is or has been applied for all configured UE-specific search space sets), the UE stops monitoring PDCCH for the indicated search space set:
a. not earlier than an application delay after an end of PDCCH reception including the indication (or an end of a monitoring occasion where the indication is received); and
b. for DL DCI format(s) of the search space set, upon expiration of drx-RetransmissionTimerDL if drx-HARQ-RTT-TimerDL or drx-RetransmissionTimerDL is running; and
c. for UL DCI format(s) of the search space set, upon expiration of drx-RetransmissionTimerUL if drx-HARQ-RTT-TimerUL or drx-RetransmissionTimerUL is running; and
d. stop drx-onDurationTimer or drx-InactivityTimer if drx-onDurationTimer or drx-InactivityTimer is running.

In one example, if a UE is provided search space sets to monitor PDCCH for detection of DCI format 0_1 and DCI format 1_1 and if one or both of DCI format 0_1 and DCI format 1_1 include a PDCCH skipping indication field:
a. the PDCCH skipping indication field is a bitmap with size equal to a number of configured search space sets (or a number of groups of configured search space sets), provided by searchSpaceGroupList;
b. each bit of the bitmap corresponds to a configured search space set (or a group of configured search space sets) from the number of configured search space sets (or the number of groups of configured search space sets);
c. a ‘1’ value for a bit of the bitmap indicates PDCCH skipping for a corresponding search space set (or a corresponding group of search space sets); and
d. a ‘0’ value for a bit of the bitmap indicates:
   i. continue monitoring PDCCH for a corresponding search space set (or a corresponding group of search space sets), if PDCCH skipping was not activated for the corresponding search space set (or the corresponding group of search space sets); and
   ii. restart monitoring PDCCH for a corresponding search space set (or a corresponding group of search space sets), if PDCCH skipping was activated for the corresponding search space set (or the corresponding group of search space sets).

According to a third embodiment, a UE may prefer to adapt (e.g., reduce) the number of transmission Tx (or reception Rx) antennas/antenna ports and/or number of maximum multiple input-multiple output (“MIMO”) layers for an active BWP. This may be for power savings (e.g., turn-off antennas), to reduce overall transmit power to address thermal issues, and/or due to UE implementation constraints such as form factor limitations, antenna placement, antenna correlation, antenna coupling etc. For example, a UE may prefer to operate with a single Tx antenna port transmission e.g., when a foldable device is closed, and with uplink MIMO (e.g., codebook or non-codebook) transmission support (more than one Tx antenna port simultaneous transmission) when the foldable device is open.

In one embodiment, the UE may indicate to the network a change in the current configuration/capability of the number of Tx (or Rx) antennas/antenna ports and/or number of maximum MIMO layers and may indicate a preferred number of Tx (or Rx) antennas/antenna ports and/or number of maximum MIMO layers for an active BWP e.g., based on an operation state of the device. In one example, the preferred configuration (e.g., once acknowledged by the network) is valid until a subsequent update to the preferred configuration. In one example, the preferred number of Tx (or Rx) antennas/antenna ports and/or number of maximum MIMO layers may not be larger than the most recent RRC configuration associated to the number of Tx (or Rx) antennas/antenna ports and/or number of maximum MIMO layers.

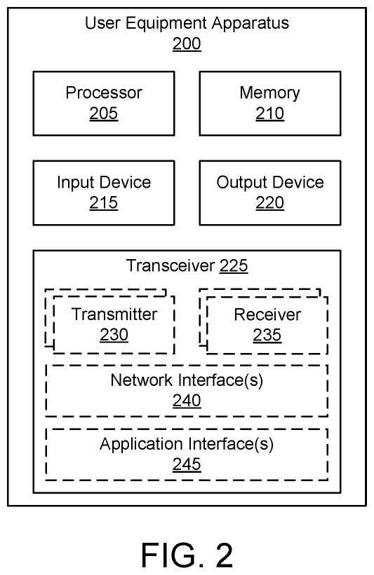

FIG. 2 depicts a user equipment apparatus 200 that may be used for enhanced discontinuous reception and power saving for user equipment, according to embodiments of the disclosure. In various embodiments, the user equipment apparatus 200 is used to implement one or more of the solutions described above. The user equipment apparatus 200 may be one embodiment of the remote unit 105 and/or the UE 205, described above. Furthermore, the user equipment apparatus 200 may include a processor 205, a memory 210, an input device 215, an output device 220, and a transceiver 225.

In some embodiments, the input device 215 and the output device 220 are combined into a single device, such as a touchscreen. In certain embodiments, the user equipment apparatus 200 may not include any input device 215 and/or output device 220. In various embodiments, the user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. In some embodiments, the transceiver 225 communicates with one or more cells (or wireless coverage areas) supported by one or more base units 121. In various embodiments, the transceiver 225 is operable on unlicensed spectrum. Moreover, the transceiver 225 may include multiple UE panel supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205, in one embodiment, may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 205 executes instructions stored in the memory 210 to perform the methods and routines described herein. The processor 205 is communicatively coupled to the memory 210, the input device 215, the output device 220, and the transceiver 225. In certain embodiments, the processor 205 may include an application processor (also known as “main processor”) which manages application-domain and operating system (“OS”) functions and a baseband processor (also known as “baseband radio processor”) which manages radio functions.

In one embodiment, the transceiver 225 receives a physical downlink control channel (“PDCCH”) skipping indication for a group of search space sets via a downlink control information (“DCI”) from a network node during a PDCCH monitoring occasion. In one embodiment, the processor 205 that ceases monitoring PDCCH for the group of search space sets at least after an elapse of an application delay, in response to the PDCCH skipping indication indicating PDCCH skipping for the group of search space sets.

In one embodiment, the processor 205 further ceases monitoring PDCCH for the group of search space sets upon the elapse of the application delay after an end of PDCCH reception that comprises the PDCCH skipping indication.

In one embodiment, the processor 205 further ceases monitoring PDCCH for the group of search space sets upon the elapse of the application delay after an end of the PDCCH monitoring occasion where the PDCCH skipping indication is received.

In one embodiment, the processor 205 further ceases monitoring PDCCH for the group of search space sets according to a timer in response to the PDCCH skipping indication indicating PDCCH skipping for the group of search space sets and no active UE-specific search space set not comprising the group of search space sets.

In one embodiment, the processor 205 further, for downlink DCI of the group of search space sets, ceases monitoring PDCCH for the group of search space sets upon expiration of the timer, the timer comprising a downlink discontinuous reception retransmission timer.

In one embodiment, the processor 205 further, for uplink DCI of the group of search space sets, ceasing monitoring PDCCH for the group of search space sets upon expiration of the timer, the timer comprising an uplink discontinuous reception retransmission timer.

In one embodiment, the processor 205 further determines a first plurality of PDCCH monitoring occasions and a second plurality of PDCCH monitoring occasions, detects a first power-saving PDCCH on a first PDCCH monitoring occasion of the first plurality of PDCCH monitoring occasions, determines whether to monitor a power-saving PDCCH on at least one PDCCH monitoring occasion of the second plurality of PDCCH monitoring occasions based on the detected first power-saving PDCCH, and detects a second power-saving PDCCH on a second PDCCH monitoring occasion of the second plurality of PDCCH monitoring occasions, in response to determining to monitor the power-saving PDCCH on the at least one PDCCH monitoring occasion of the second plurality of PDCCH monitoring occasions.

In one embodiment, the transceiver 225 further receives the PDCCH skipping indication by starting monitoring PDCCH for the group of search space sets in response to detecting the second power-saving PDCCH.

In one embodiment, the transceiver 225 further receives a first configuration information associated with a first type of power-saving PDCCH and receives a second configuration information associated with a second type of power-saving PDCCH, wherein the first type of power-saving PDCCH is monitored on the first plurality of PDCCH monitoring occasions and the second type of power-saving PDCCH is monitored on the second plurality of PDCCH monitoring occasions.

In one embodiment, the first configuration comprises at least one selected from a group comprising a first power saving-radio network temporary identifier (“PS-RNTI”), a first at least one search space set, a first payload size of the first type of power-saving PDCCH, a first starting position of an assigned block in DCI, and a time offset and the second configuration comprises at least one selected from a group comprising a second power saving-radio network temporary identifier (“PS-RNTI”), a second at least one search space set, a second payload size of the second type of power-saving PDCCH, and a second starting position of an assigned block in DCI.

In one embodiment, the transceiver 225 further receives a power-saving PDCCH of the second type of power-saving PDCCH based on the first configuration information and the second configuration information.

In one embodiment, the transceiver 225 further receives a discontinuous reception (“DRX”) configuration, the DRX configuration comprising a set of DRX ON duration timer values and a set of configurations where each configuration indicates whether to start an associated DRX ON duration timer based on the set of DRX ON duration timer values when a corresponding power-saving PDCCH is monitored, but not detected.

In one embodiment, the set of DRX ON duration timer values comprises a first DRX ON duration timer value associated with the first plurality of PDCCH monitoring occasions and a second DRX ON duration timer value associated with the second plurality of PDCCH monitoring occasions.

In one embodiment, the set of DRX ON duration timer values comprises a first DRX ON duration timer value associated with the first plurality of PDCCH monitoring occasions, and the processor 205 further determines a second DRX ON duration timer value based on the first DRX ON duration timer value.

In one embodiment, the first PDCCH monitoring occasion is within a first DRX cycle and the second PDCCH monitoring occasion is within a second DRX cycle, the first DRX cycle occurring prior to the second DRX cycle.

In one embodiment, the processor 205 further determines whether to start a DRX ON duration timer associated with the second DRX cycle based on the detected second power-saving PDCCH.

The memory 210, in one embodiment, is a computer readable storage medium. In some embodiments, the memory 210 includes volatile computer storage media. For example, the memory 210 may include a RAM, including dynamic RAM (“DRAM”), synchronous dynamic RAM (“SDRAM”), and/or static RAM (“SRAM”). In some embodiments, the memory 210 includes non-volatile computer storage media. For example, the memory 210 may include a hard disk drive, a flash memory, or any other suitable non-volatile computer storage device. In some embodiments, the memory 210 includes both volatile and non-volatile computer storage media.

In some embodiments, the memory 210 stores data related to enhanced discontinuous reception and power saving for user equipment. For example, the memory 210 may store various parameters, panel/beam configurations, resource assignments, policies, and the like, as described above. In certain embodiments, the memory 210 also stores program code and related data, such as an operating system or other controller algorithms operating on the user equipment apparatus 200.

The input device 215, in one embodiment, may include any known computer input device including a touch panel, a button, a keyboard, a stylus, a microphone, or the like. In some embodiments, the input device 215 may be integrated with the output device 220, for example, as a touchscreen or similar touch-sensitive display. In some embodiments, the input device 215 includes a touchscreen such that text may be input using a virtual keyboard displayed on the touchscreen and/or by handwriting on the touchscreen. In some embodiments, the input device 215 includes two or more different devices, such as a keyboard and a touch panel.

The output device 220, in one embodiment, is designed to output visual, audible, and/or haptic signals. In some embodiments, the output device 220 includes an electronically controllable display or display device capable of outputting visual data to a user. For example, the output device 220 may include, but is not limited to, an LCD display, an LED display, an OLED display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

In certain embodiments, the output device 220 includes one or more speakers for producing sound. For example, the output device 220 may produce an audible alert or notification (e.g., a beep or chime). In some embodiments, the output device 220 includes one or more haptic devices for producing vibrations, motion, or other haptic feedback. In some embodiments, all, or portions of the output device 220 may be integrated with the input device 215. For example, the input device 215 and output device 220 may form a touchscreen or similar touch-sensitive display. In other embodiments, the output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least transmitter 230 and at least one receiver 235. One or more transmitters 230 may be used to provide UL communication signals to a base unit 121, such as the UL transmissions described herein. Similarly, one or more receivers 235 may be used to receive DL communication signals from the base unit 121, as described herein. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. In one embodiment, the transceiver 225 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

In various embodiments, one or more transmitters 230 and/or one or more receivers 235 may be implemented and/or integrated into a single hardware component, such as a multi-transceiver chip, a system-on-a-chip, an ASIC, or other type of hardware component. In certain embodiments, one or more transmitters 230 and/or one or more receivers 235 may be implemented and/or integrated into a multi-chip module. In some embodiments, other components such as the network interface 240 or other hardware components/circuits may be integrated with any number of transmitters 230 and/or receivers 235 into a single chip. In such embodiment, the transmitters 230 and receivers 235 may be logically configured as a transceiver 225 that uses one more common control signals or as modular transmitters 230 and receivers 235 implemented in the same hardware chip or in a multi-chip module.

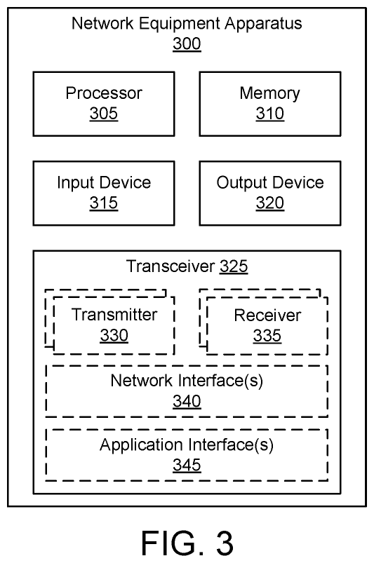

FIG. 3 depicts a network apparatus 300 that may be used for enhanced discontinuous reception and power saving for user equipment, according to embodiments of the disclosure. In one embodiment, network apparatus 300 may be one implementation of a RAN node, such as the base unit 121, the RAN node 210, or gNB, described above. Furthermore, the base network apparatus 300 may include a processor 305, a memory 310, an input device 315, an output device 320, and a transceiver 325.

In some embodiments, the input device 315 and the output device 320 are combined into a single device, such as a touchscreen. In certain embodiments, the network apparatus 300 may not include any input device 315 and/or output device 320. In various embodiments, the network apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 105. Additionally, the transceiver 325 may support at least one network interface 340 and/or application interface 345. The application interface(s) 345 may support one or more. The network interface(s) 340 may support 3GPP reference points, such as Uu, N1, N2 and N3. Other network interfaces 340 may be supported, as understood by one of ordinary skill in the art.

The processor 305, in one embodiment, may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. In some embodiments, the processor 305 executes instructions stored in the memory 310 to perform the methods and routines described herein. The processor 305 is communicatively coupled to the memory 310, the input device 315, the output device 320, and the transceiver 325. In certain embodiments, the processor 805 may include an application processor (also known as “main processor”) which manages application-domain and operating system (“OS”) functions and a baseband processor (also known as “baseband radio processor”) which manages radio function.

In various embodiments, the network apparatus 300 is a RAN node (e.g., gNB) that includes a processor 305 and a transceiver 325. In one embodiment, the transceiver 325 transmits a physical downlink control channel (“PDCCH”) skipping indication for a group of search space sets configured for a user equipment (“UE”) device via a downlink control information (“DCI”) during a PDCCH monitoring occasion and the processor 305 ceases transmitting PDCCH for the group of search space sets at least after an elapse of an application delay, in response to transmitting the PDCCH skipping indication indicating PDCCH skipping for the group of search space sets.

The memory 310, in one embodiment, is a computer readable storage medium. In some embodiments, the memory 310 includes volatile computer storage media. For example, the memory 310 may include a RAM, including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data related to enhanced discontinuous reception and power saving for user equipment. For example, the memory 310 may store parameters, configurations, resource assignments, policies, and the like, as described above. In certain embodiments, the memory 310 also stores program code and related data, such as an operating system or other controller algorithms operating on the network apparatus 300.

The input device 315, in one embodiment, may include any known computer input device including a touch panel, a button, a keyboard, a stylus, a microphone, or the like. In some embodiments, the input device 315 may be integrated with the output device 320, for example, as a touchscreen or similar touch-sensitive display. In some embodiments, the input device 315 includes a touchscreen such that text may be input using a virtual keyboard displayed on the touchscreen and/or by handwriting on the touchscreen. In some embodiments, the input device 315 includes two or more different devices, such as a keyboard and a touch panel.

The output device 320, in one embodiment, is designed to output visual, audible, and/or haptic signals. In some embodiments, the output device 320 includes an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

In certain embodiments, the output device 320 includes one or more speakers for producing sound. For example, the output device 320 may produce an audible alert or notification (e.g., a beep or chime). In some embodiments, the output device 320 includes one or more haptic devices for producing vibrations, motion, or other haptic feedback. In some embodiments, all, or portions of the output device 320 may be integrated with the input device 315. For example, the input device 315 and output device 320 may form a touchscreen or similar touch-sensitive display. In other embodiments, the output device 320 may be located near the input device 315.

The transceiver 325 includes at least transmitter 330 and at least one receiver 335. One or more transmitters 330 may be used to communicate with the UE, as described herein. Similarly, one or more receivers 335 may be used to communicate with network functions in the NPN, PLMN and/or RAN, as described herein. Although only one transmitter 330 and one receiver 335 are illustrated, the network apparatus 300 may have any suitable number of transmitters 330 and receivers 335. Further, the transmitter(s) 330 and the receiver(s) 335 may be any suitable type of transmitters and receivers.

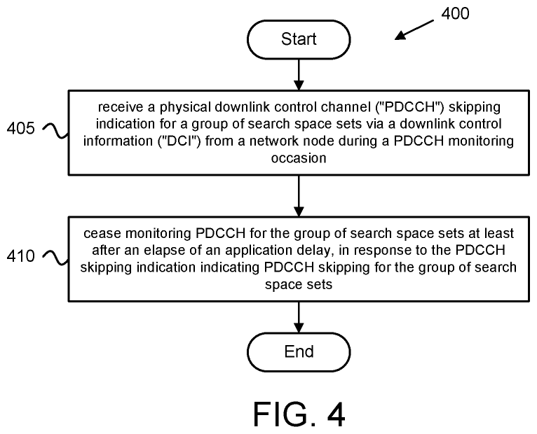

FIG. 4 is a flowchart diagram of a method 400 for enhanced discontinuous reception and power saving for user equipment. The method 400 may be performed by a UE as described herein, for example, the remote unit 105, the UE 205 and/or the user equipment apparatus 200. In some embodiments, the method 400 may be performed by a processor executing program code, for example, a microcontroller, a microprocessor, a CPU, a GPU, an auxiliary processing unit, a FPGA, or the like.

In one embodiment, the method 400 includes receiving 405 a physical downlink control channel (“PDCCH”) skipping indication for a group of search space sets via a downlink control information (“DCI”) from a network node during a PDCCH monitoring occasion and ceasing 410 monitoring PDCCH for the group of search space sets at least after an elapse of an application delay, in response to the PDCCH skipping indication indicating PDCCH skipping for the group of search space sets. The method 400 ends.

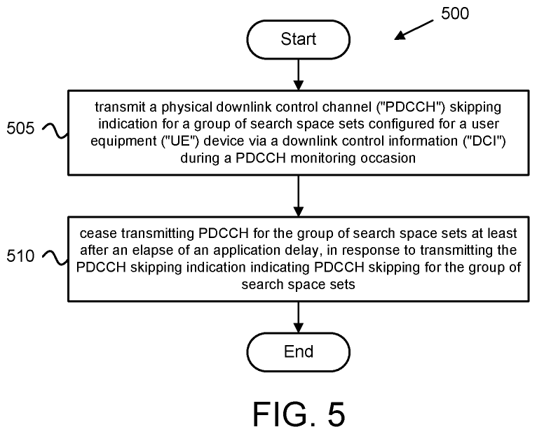

FIG. 5 is a flowchart diagram of a method 500 for enhanced discontinuous reception and power saving for user equipment. The method 500 may be performed by a network device as described herein, for example, a RAN node, a gNB, and/or the network equipment apparatus 300. In some embodiments, the method 500 may be performed by a processor executing program code, for example, a microcontroller, a microprocessor, a CPU, a GPU, an auxiliary processing unit, a FPGA, or the like.

The method 500 includes transmitting 505 a physical downlink control channel (“PDCCH”) skipping indication for a group of search space sets configured for a user equipment (“UE”) device via a downlink control information (“DCI”) during a PDCCH monitoring occasion and ceasing 510 transmitting PDCCH for the group of search space sets at least after an elapse of an application delay, in response to transmitting the PDCCH skipping indication indicating PDCCH skipping for the group of search space sets. The method 500 ends.

Disclosed herein is a first apparatus for enhanced discontinuous reception and power saving for user equipment. The first apparatus may include a UE as described herein, for example, the remote unit 105, the UE 205 and/or the user equipment apparatus 200. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver that receives a physical downlink control channel (“PDCCH”) skipping indication for a group of search space sets via a downlink control information (“DCI”) from a network node during a PDCCH monitoring occasion. In one embodiment, the first apparatus includes a processor that ceases monitoring PDCCH for the group of search space sets at least after an elapse of an application delay, in response to the PDCCH skipping indication indicating PDCCH skipping for the group of search space sets.

In one embodiment, the processor further ceases monitoring PDCCH for the group of search space sets upon the elapse of the application delay after an end of PDCCH reception that comprises the PDCCH skipping indication.

In one embodiment, the processor further ceases monitoring PDCCH for the group of search space sets upon the elapse of the application delay after an end of the PDCCH monitoring occasion where the PDCCH skipping indication is received.

In one embodiment, the processor further ceases monitoring PDCCH for the group of search space sets according to a timer in response to the PDCCH skipping indication indicating PDCCH skipping for the group of search space sets and no active UE-specific search space set not comprising the group of search space sets.

In one embodiment, the processor further, for downlink DCI of the group of search space sets, ceases monitoring PDCCH for the group of search space sets upon expiration of the timer, the timer comprising a downlink discontinuous reception retransmission timer.

In one embodiment, the processor further, for uplink DCI of the group of search space sets, ceases monitoring PDCCH for the group of search space sets upon expiration of the timer, the timer comprising an uplink discontinuous reception retransmission timer.

In one embodiment, the processor further determines a first plurality of PDCCH monitoring occasions and a second plurality of PDCCH monitoring occasions, detects a first power-saving PDCCH on a first PDCCH monitoring occasion of the first plurality of PDCCH monitoring occasions, determines whether to monitor a power-saving PDCCH on at least one PDCCH monitoring occasion of the second plurality of PDCCH monitoring occasions based on the detected first power-saving PDCCH, and detects a second power-saving PDCCH on a second PDCCH monitoring occasion of the second plurality of PDCCH monitoring occasions, in response to determining to monitor the power-saving PDCCH on the at least one PDCCH monitoring occasion of the second plurality of PDCCH monitoring occasions.

In one embodiment, the transceiver further receives the PDCCH skipping indication by starting monitoring PDCCH for the group of search space sets in response to detecting the second power-saving PDCCH.

In one embodiment, the transceiver further receives a first configuration information associated with a first type of power-saving PDCCH and receives a second configuration information associated with a second type of power-saving PDCCH, wherein the first type of power-saving PDCCH is monitored on the first plurality of PDCCH monitoring occasions and the second type of power-saving PDCCH is monitored on the second plurality of PDCCH monitoring occasions.

In one embodiment, the first configuration comprises at least one selected from a group comprising a first power saving-radio network temporary identifier (“PS-RNTI”), a first at least one search space set, a first payload size of the first type of power-saving PDCCH, a first starting position of an assigned block in DCI, and a time offset and the second configuration comprises at least one selected from a group comprising a second power saving-radio network temporary identifier (“PS-RNTI”), a second at least one search space set, a second payload size of the second type of power-saving PDCCH, and a second starting position of an assigned block in DCI.

In one embodiment, the transceiver further receives a power-saving PDCCH of the second type of power-saving PDCCH based on the first configuration information and the second configuration information.

In one embodiment, the transceiver further receives a discontinuous reception (“DRX”) configuration, the DRX configuration comprising a set of DRX ON duration timer values and a set of configurations where each configuration indicates whether to start an associated DRX ON duration timer based on the set of DRX ON duration timer values when a corresponding power-saving PDCCH is monitored, but not detected.

In one embodiment, the set of DRX ON duration timer values comprises a first DRX ON duration timer value associated with the first plurality of PDCCH monitoring occasions and a second DRX ON duration timer value associated with the second plurality of PDCCH monitoring occasions.

In one embodiment, the set of DRX ON duration timer values comprises a first DRX ON duration timer value associated with the first plurality of PDCCH monitoring occasions, and the processor further determines a second DRX ON duration timer value based on the first DRX ON duration timer value.

In one embodiment, the first PDCCH monitoring occasion is within a first DRX cycle and the second PDCCH monitoring occasion is within a second DRX cycle, the first DRX cycle occurring prior to the second DRX cycle.

In one embodiment, the processor further determines whether to start a DRX ON duration timer associated with the second DRX cycle based on the detected second power-saving PDCCH.

Disclosed herein is a first method for enhanced discontinuous reception and power saving for user equipment. The first method may be performed by a UE as described herein, for example, the remote unit 105, the UE 205 and/or the user equipment apparatus 200. In some embodiments, the first method may be performed by a processor executing program code, for example, a microcontroller, a microprocessor, a CPU, a GPU, an auxiliary processing unit, a FPGA, or the like.

In one embodiment, the first method includes receiving a physical downlink control channel (“PDCCH”) skipping indication for a group of search space sets via a downlink control information (“DCI”) from a network node during a PDCCH monitoring occasion. In one embodiment, the first method includes ceasing monitoring PDCCH for the group of search space sets at least after an elapse of an application delay, in response to the PDCCH skipping indication indicating PDCCH skipping for the group of search space sets.

In one embodiment, the first method includes ceasing monitoring PDCCH for the group of search space sets upon the elapse of the application delay after an end of PDCCH reception that comprises the PDCCH skipping indication.

In one embodiment, the first method includes ceasing monitoring PDCCH for the group of search space sets upon the elapse of the application delay after an end of the PDCCH monitoring occasion where the PDCCH skipping indication is received.

In one embodiment, the first method includes ceasing monitoring PDCCH for the group of search space sets according to a timer in response to the PDCCH skipping indication indicating PDCCH skipping for the group of search space sets and no active UE-specific search space set not comprising the group of search space sets.

In one embodiment, the first method includes, for downlink DCI of the group of search space sets, ceasing monitoring PDCCH for the group of search space sets upon expiration of the timer, the timer comprising a downlink discontinuous reception retransmission timer.

In one embodiment, the first method includes, for uplink DCI of the group of search space sets, ceasing monitoring PDCCH for the group of search space sets upon expiration of the timer, the timer comprising an uplink discontinuous reception retransmission timer.

In one embodiment, the first method includes determining a first plurality of PDCCH monitoring occasions and a second plurality of PDCCH monitoring occasions, detects a first power-saving PDCCH on a first PDCCH monitoring occasion of the first plurality of PDCCH monitoring occasions, determines whether to monitor a power-saving PDCCH on at least one PDCCH monitoring occasion of the second plurality of PDCCH monitoring occasions based on the detected first power-saving PDCCH, and detects a second power-saving PDCCH on a second PDCCH monitoring occasion of the second plurality of PDCCH monitoring occasions, in response to determining to monitor the power-saving PDCCH on the at least one PDCCH monitoring occasion of the second plurality of PDCCH monitoring occasions.

In one embodiment, the first method includes receiving the PDCCH skipping indication by starting monitoring PDCCH for the group of search space sets in response to detecting the second power-saving PDCCH.

In one embodiment, the first method includes receiving a first configuration information associated with a first type of power-saving PDCCH and receives a second configuration information associated with a second type of power-saving PDCCH, wherein the first type of power-saving PDCCH is monitored on the first plurality of PDCCH monitoring occasions and the second type of power-saving PDCCH is monitored on the second plurality of PDCCH monitoring occasions.

In one embodiment, the first configuration comprises at least one selected from a group comprising a first power saving-radio network temporary identifier (“PS-RNTI”), a first at least one search space set, a first payload size of the first type of power-saving PDCCH, a first starting position of an assigned block in DCI, and a time offset and the second configuration comprises at least one selected from a group comprising a second power saving-radio network temporary identifier (“PS-RNTI”), a second at least one search space set, a second payload size of the second type of power-saving PDCCH, and a second starting position of an assigned block in DCI.

In one embodiment, the first method includes receiving a power-saving PDCCH of the second type of power-saving PDCCH based on the first configuration information and the second configuration information.

In one embodiment, the first method includes receiving a discontinuous reception (“DRX”) configuration, the DRX configuration comprising a set of DRX ON duration timer values and a set of configurations where each configuration indicates whether to start an associated DRX ON duration timer based on the set of DRX ON duration timer values when a corresponding power-saving PDCCH is monitored, but not detected.

In one embodiment, the set of DRX ON duration timer values comprises a first DRX ON duration timer value associated with the first plurality of PDCCH monitoring occasions and a second DRX ON duration timer value associated with the second plurality of PDCCH monitoring occasions.

In one embodiment, the set of DRX ON duration timer values comprises a first DRX ON duration timer value associated with the first plurality of PDCCH monitoring occasions, and the first method includes determining a second DRX ON duration timer value based on the first DRX ON duration timer value.

In one embodiment, the first PDCCH monitoring occasion is within a first DRX cycle and the second PDCCH monitoring occasion is within a second DRX cycle, the first DRX cycle occurring prior to the second DRX cycle.

In one embodiment, the first method includes determining whether to start a DRX ON duration timer associated with the second DRX cycle based on the detected second power-saving PDCCH.

Disclosed herein is a second apparatus for enhanced discontinuous reception and power saving for user equipment. The second apparatus may include a network device as described herein, for example, a RAN node, a gNB, and/or the network equipment apparatus 300. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver that transmits a physical downlink control channel (“PDCCH”) skipping indication for a group of search space sets configured for a user equipment (“UE”) device via a downlink control information (“DCI”) during a PDCCH monitoring occasion and a processor that ceases transmitting PDCCH for the group of search space sets at least after an elapse of an application delay, in response to transmitting the PDCCH skipping indication indicating PDCCH skipping for the group of search space sets.

Disclosed herein is a second method for enhanced discontinuous reception and power saving for user equipment. The second method may be performed by a network device as described herein, for example, a RAN node, a gNB, and/or the network equipment apparatus 300. In some embodiments, the second method may be performed by a processor executing program code, for example, a microcontroller, a microprocessor, a CPU, a GPU, an auxiliary processing unit, a FPGA, or the like.

In one embodiment, the second method includes transmitting a physical downlink control channel (“PDCCH”) skipping indication for a group of search space sets configured for a user equipment (“UE”) device via a downlink control information (“DCI”) during a PDCCH monitoring occasion and ceasing transmitting PDCCH for the group of search space sets at least after an elapse of an application delay, in response to transmitting the PDCCH skipping indication indicating PDCCH skipping for the group of search space sets.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) for wireless communication, comprising:
at least one memory; and
at least one processor coupled with the at least one memory and configured to cause the UE to:
receive a physical downlink control channel (“PDCCH”) skipping indication for a group of search space sets via a downlink control information (“DCI”) from a network node during a PDCCH monitoring occasion; and
cease monitoring PDCCH for the group of search space sets at least after an elapse of an application delay, in response to the PDCCH skipping indication indicating PDCCH skipping for the group of search space sets.

2. The UE of claim 1, wherein the at least one processor is configured to cause the UE to cease monitoring PDCCH for the group of search space sets upon the elapse of the application delay after an end of PDCCH reception that comprises the PDCCH skipping indication.

3. The UE of claim 1, wherein the at least one processor is configured to cause the UE to cease monitoring PDCCH for the group of search space sets upon the elapse of the application delay after an end of the PDCCH monitoring occasion where the PDCCH skipping indication is received.

4. The UE of claim 1, wherein the at least one processor is configured to cause the UE to cease monitoring PDCCH for the group of search space sets according to a timer in response to:
the PDCCH skipping indication indicating PDCCH skipping for the group of search space sets; and
no active UE-specific search space set not comprising the group of search space sets.

5. The UE of claim 4, wherein the at least one processor is configured to cause the UE to:
for downlink DCI of the group of search space sets, cease monitoring PDCCH for the group of search space sets upon expiration of the timer, the timer comprising a downlink discontinuous reception retransmission timer; and
for uplink DCI of the group of search space sets, cease monitoring PDCCH for the group of search space sets upon expiration of the timer, the timer comprising an uplink discontinuous reception retransmission timer.

6. The UE of claim 1, wherein the at least one processor is configured to cause the UE to:
determine a first plurality of PDCCH monitoring occasions and a second plurality of PDCCH monitoring occasions;
detect a first power-saving PDCCH on a first PDCCH monitoring occasion of the first plurality of PDCCH monitoring occasions;
determine whether to monitor a power-saving PDCCH on at least one PDCCH monitoring occasion of the second plurality of PDCCH monitoring occasions based on the detected first power-saving PDCCH;
detect a second power-saving PDCCH on a second PDCCH monitoring occasion of the second plurality of PDCCH monitoring occasions, in response to determining to monitor the power-saving PDCCH on the at least one PDCCH monitoring occasion of the second plurality of PDCCH monitoring occasions; and
receive the PDCCH skipping indication by starting monitoring PDCCH for the group of search space sets in response to detecting the second power-saving PDCCH.

7. The UE of claim 6, wherein the at least one processor is configured to cause the UE to:
receive a first configuration information associated with a first type of power-saving PDCCH; and
receive a second configuration information associated with a second type of power-saving PDCCH,
wherein the first type of power-saving PDCCH is monitored on the first plurality of PDCCH monitoring occasions and the second type of power-saving PDCCH is monitored on the second plurality of PDCCH monitoring occasions.

8. The UE of claim 7, wherein:
the first configuration comprises at least one selected from a group comprising a first power saving-radio network temporary identifier (“PS-RNTI”), a first at least one search space set, a first payload size of the first type of power-saving PDCCH, a first starting position of an assigned block in DCI, and a time offset; and
the second configuration comprises at least one selected from a group comprising a second power saving-radio network temporary identifier (“PS-RNTI”), a second at least one search space set, a second payload size of the second type of power-saving PDCCH, and a second starting position of an assigned block in DCI.

9. The UE of claim 8, wherein the at least one processor is configured to cause the UE to receive a discontinuous reception (“DRX”) configuration, the DRX configuration comprising a set of DRX ON duration timer values and a set of configurations where each configuration indicates whether to start an associated DRX ON duration timer based on the set of DRX ON duration timer values when a corresponding power-saving PDCCH is monitored, but not detected.

10. The UE of claim 9, wherein the set of DRX ON duration timer values comprises a first DRX ON duration timer value associated with the first plurality of PDCCH monitoring occasions and a second DRX ON duration timer value associated with the second plurality of PDCCH monitoring occasions.

11. The UE of claim 9, wherein the set of DRX ON duration timer values comprises a first DRX ON duration timer value associated with the first plurality of PDCCH monitoring occasions, and the processor further determines a second DRX ON duration timer value based on the first DRX ON duration timer value.

12. The UE of claim 6, wherein the first PDCCH monitoring occasion is within a first DRX cycle and the second PDCCH monitoring occasion is within a second DRX cycle, the first DRX cycle occurring prior to the second DRX cycle.

13. The UE of claim 12, wherein the at least one processor is configured to cause the UE to further determine whether to start a DRX ON duration timer associated with the second DRX cycle based on the detected second power-saving PDCCH.

14. A method performed by a user equipment (“UE”), the method comprising:
receiving a physical downlink control channel (“PDCCH”) skipping indication for a group of search space sets via a downlink control information (“DCI”) from a network node during a PDCCH monitoring occasion; and
ceasing monitoring PDCCH for the group of search space sets at least after an elapse of an application delay, in response to the PDCCH skipping indication indicating PDCCH skipping for the group of search space sets.

15. A base station for wireless communication, comprising:
at least one memory; and
at least one processor coupled with the at least one memory and configured to cause the base station to:
transmit a physical downlink control channel (“PDCCH”) skipping indication for a group of search space sets configured for a user equipment (“UE”) device via a downlink control information (“DCI”) during a PDCCH monitoring occasion; and
cease transmitting PDCCH for the group of search space sets at least after an elapse of an application delay, in response to transmitting the PDCCH skipping indication indicating PDCCH skipping for the group of search space sets.

16. A processor for wireless communication, comprising:
at least one controller coupled with at least one memory and configured to cause the processor to:
receive a physical downlink control channel (“PDCCH”) skipping indication for a group of search space sets via a downlink control information (“DCI”) from a network node during a PDCCH monitoring occasion; and
cease monitoring PDCCH for the group of search space sets at least after an elapse of an application delay, in response to the PDCCH skipping indication indicating PDCCH skipping for the group of search space sets.

17. The processor of claim 16, wherein the at least one controller is configured to cause the processor to cease monitoring PDCCH for the group of search space sets upon the elapse of the application delay after an end of PDCCH reception that comprises the PDCCH skipping indication.

18. The processor of claim 16, wherein the at least one controller is configured to cause the processor to cease monitoring PDCCH for the group of search space sets upon the elapse of the application delay after an end of the PDCCH monitoring occasion where the PDCCH skipping indication is received.

19. The processor of claim 16, wherein the at least one controller is configured to cause the processor to cease monitoring PDCCH for the group of search space sets according to a timer in response to:
the PDCCH skipping indication indicating PDCCH skipping for the group of search space sets; and
no active UE-specific search space set not comprising the group of search space sets.

20. The processor of claim 19, wherein the at least one controller is configured to cause the processor to:
for downlink DCI of the group of search space sets, cease monitoring PDCCH for the group of search space sets upon expiration of the timer, the timer comprising a downlink discontinuous reception retransmission timer; and
for uplink DCI of the group of search space sets, cease monitoring PDCCH for the group of search space sets upon expiration of the timer, the timer comprising an uplink discontinuous reception retransmission timer.
